(19) United States
(12) Patent Application Publication
(10) Pub. No.: US 2005/0045595 A1
(43) Pub. Date: Mar. 3, 2005

(54) Pressure-limiting valve for a puffer interrupter assembly

(76) Inventor: Christian Daehler, Greensburg, PA (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/654,671

(22) Filed: Sep. 3, 2003

(51) Int. Cl. H01H 33/88

(52) U.S. Cl. 218/57

(57) ABSTRACT

Another preferred embodiment of a valve for a puffer interrupter assembly includes a body for mounting in the puffer interrupter assembly. The body has a through hole formed therein and extending between a first and a second major surface thereof. The valve also includes a ring member having a first major surface contacting the second major surface of the body and covering the through hole on a selective basis. The valve also includes a wave spring contacting a second major surface of the ring member.

### FIELD OF THE INVENTION

The present invention relates generally to circuit breakers of the type comprising a puffer interrupter assembly. More specifically, the invention relates to a valve for limiting gas pressure within the puffer interrupter assembly.

### BACKGROUND OF THE INVENTION

FIGS. 14 and 15 depict a circuit breaker interrupter 300 comprising a puffer interrupter assembly 301 having a conventional pressure-limiting valve 302.

The puffer interrupter assembly 301 also comprises a support shield 332, a moving contact support 333, and a movable contact assembly 334.

The movable contact assembly 334 comprises a moving contact cylinder 335 fixedly coupled to the moving contact support 333, and an insulating nozzle 336 fixedly coupled to the moving contact cylinder 335 (see FIG. 2). The movable contact assembly 334 also comprises a main cylinder 340, a blast tube 342, and arcing contact fingers 344.

The main cylinder 340 and the arcing contact fingers 344 are fixedly coupled to the blast tube 342, and the moving contact cylinder 335 is fixedly coupled to the main cylinder 340. The blast tube 342 extends through the support shield 332 and the moving contact support 333. The blast tube 342 (and the main cylinder 340) can translate axially, i.e., in the “x” direction, in relation to the support shield 332.

The puffer interrupter assembly 301 also includes an operating lever 407, an insulated operating rod 408, and an operating mechanism (not shown) that rotates the operating lever on a selective basis (see FIG. 1). The operating lever is mechanically coupled to an end of the insulated operating rod 408. Rotation of the operating lever causes the insulated operating rod 408 to translate in the axial direction.

The puffer interrupter assembly 301 further comprises a pressure-limiting valve 302. The valve 302 is mechanically coupled to the support shield 332 by way of the moving contact support 333 and a connecting plate 338.

The puffer interrupter assembly 301 also comprises a stationary contact assembly 352 and a support shield 354. The stationary contact assembly 352 comprises a stationary contact support 356. The stationary contact support 356 is positioned within, and is fixedly coupled to the support shield 354.

The stationary contact assembly 352 also comprises an arcing contact rod 358 and a contact assembly 360. The arcing contact rod 358 is fixedly coupled to, and extends through the stationary contact support 356. The contact assembly 360 is fixedly coupled to an end of the stationary contact support 356, and extends circumferentially around the end of the stationary contact support 356.

The free volume within the puffer interrupter assembly 301 is filed with a pressurized dielectric gas such as sulfur hexafluoride (SF₆).

The movable contact assembly 334 can translate between an “open” and a “closed” position. (The movable contact assembly 334 is shown in its open position in FIGS. 13 and 14.). More particularly, the operating rod 408 translates in the axial direction in response to actuation of the operating mechanism, as noted above. Axial movement of the operating rod 408 drives the moving contact cylinder 335 and the arcing contact fingers 344 toward or away from the respective contact assembly 360 and arcing contact rod 358 of the stationary contact assembly 352.

A forward portion of the moving contact cylinder 335 contacts the inner circumference of the contact assembly 360, and the arcing contact fingers 344 contact the arcing contact rod 358 when the movable contact assembly 334 is in its closed position. This arrangement establishes the flow of electrical current through the circuit breaker interrupter 300.

Movement of the movable contact assembly 334 to the open position breaks the above-noted contact between the moving contact cylinder 335 and the contact assembly 360, and between the arcing contact fingers 344 and the arcing contact rod 358. Movement of the movable contact assembly 334 to the open position thus interrupts the flow of electrical current though the circuit breaker.

The main cylinder 340 is fixedly coupled to the operating rod 408, and therefore translates with the moving contact cylinder 335 and the arcing contact fingers 344. Translation of the main cylinder 340 in the rearward (“−x”) direction, as the movable contact assembly 334 moves from its closed to its open position, compresses the SF₆ gas located within a volume 370 between the valve 302 and the main cylinder 340 (see FIG. 2).

The valve 302 can trap the SF₆ gas within the volume 370, and can thereby cause the SF₆ gas to compress in response to the movement of the moving contact support 333 in the rearward direction. Moreover, the valve 302 can release a portion of the SF₆ gas from the volume 370 when the pressure of the SF₆ gas reaches a predetermined level, and can thereby limit the pressure of the SF₆ gas in the volume 370.

Through holes formed in the main cylinder 340 permit the compressed SF₆ gas to flow toward the stationary contact assembly 352 in response to the elevated pressure within the volume 370. The SF₆ gas flows through the nozzle 336 after exiting the through holes formed in the main cylinder 340. The nozzle 336 directs the SF₆ gas toward the interface between the moving contact cylinder 335 and the contact assembly 360. The nozzle 336 also directs the SF₆ gas toward the interface between the arcing contact fingers 344 and the arcing contact rod 358.

The SF₆ gas can help to cool and quench the arc that forms between the moving contact cylinder 335 and the contact assembly 360 during separation thereof. The SF₆ gas can also help to cool and quench the arc that forms between the arcing contact fingers 344 and the arcing contact rod 358 during separation thereof.

The valve 302 comprises a body 380, a first ring member 381, and a second ring member 382 (see FIG. 16). The body 380 is fixedly coupled to the moving contact support 333. The body 380 has an inner circumferential surface 380a that defines a passage 384 through the body 380. A bushing 385 is positioned around a portion of the inner circumferential surface 380a. The blast tube 342 extends through the passage 384 (see FIG. 15). The blast tube 342 contacts, and slides along an inner circumference of the bushing 385.

The body 380 has six through holes 390 formed therein (two of the through holes 390 are depicted in FIG. 16). A plurality of posts 387 are secured the body 380 so that the posts 387 project from a first major surface 380b of the body 380. The first ring member 381 has a plurality of through holes 394 formed therein. The posts 387 extend through the through holes 394, as shown in FIG. 16, and thereby suspend the first ring member 381 from the body 380.

The first ring member 381 is movable in the axial (“x”) direction, between a rearward position (from the perspective of FIGS. 15 and 16) proximate the first major surface 380b, and a forward position (the first ring member 381 is shown in its rearward position in FIGS. 15 and 16). The first ring member 381 covers three of through holes 390 when the first ring member 381 is in its rearward position. The ring first ring member has three additional through holes formed therein (not shown) that substantially align with the remaining through holes 390, and therefore does not cover the remaining through holes 390.

A plurality of posts 388 are secured to the body 380 so that the posts 388 project from a second major surface 380c of the body 380. The second ring member 382 has a plurality of through holes 396 formed therein. The posts 388 extend through the through holes 396, as shown in FIG. 16, and thereby suspend the second ring member 382 from the body 380.

The second ring member 382 is movable in the axial (“x”) direction, between a forward position proximate the second major surface 380c, and a rearward position (the second ring member 382 is shown in its forward position in FIG. 16). The second ring member 382, when in its forward position, covers the three through holes 390 not covered by the first ring member 381 when the second ring member 382 is in it is rearward position. The second ring member 382 has three additional through holes formed therein that substantially align with the through holes 390 covered by the first ring member 381 when the first ring member 381 is in its rearward position.

A coil spring 389 is positioned around each of the posts 388. The coil springs 389 bias the second ring member 382 in the forward direction, toward the second major surface 380c of the body 380.

The main cylinder 340 moves in the rearward (“−x”) direction when the movable contact assembly 334 moves from its closed to its open position. The valve 302 initially traps the SF₆ gas in the volume 370. The initial movement of the main cylinder 340 thus compresses the SF₆ gas within the volume 370.

The first ring member 381 is urged into its rearward position by the increased pressure within the volume 370 caused by the rearward movement of the main cylinder 340. The first ring member 381 covers three of the through holes 390 in the body 380 when the first ring member 381 is in its rearward position. The first ring member 381 thus seals those through holes 390 and prevents substantial amounts of SF₆ gas from flowing out of the volume 370 by way of those through holes 390 as the movable contact assembly 334 initially moves toward its open position.

The second ring member 382 seals the remaining three through holes 390 when the pressure of the SF₆ gas within the volume 370 is below a predetermined value. (In other words, the second ring member 382 seals the three through holes 390 not covered by the first ring member 381 when the first ring member 381 is in its rearward position.) In particular, the springs 389 bias the second ring member 382 toward its forward position, and the second ring member 382 covers the remaining three through holes 390 when the second ring member 382 is in its forward position. The spring rate (spring constant) and preload of the springs 389 are selected so as to be high enough to cause the springs 389 to exert an aggregate force sufficient to hold the second ring member 382 in its forward position, against the second major surface 380c of the body 380, as the moving contact assembly 334 initially moves toward its open position. The second ring member 382 thus seals the three through holes 390 not covered by the first ring member 381, during the initial period of movement of the movable contact assembly 334.

Movement of the movable contact assembly 334 from its closed to its open position causes the piston 440 to move rearward, as discussed previously. The sealing of the through holes 390 by the respective first and second ring members 381, 382 causes the pressure of the SF₆ gas within the volume 370 to increase in response to the initial rearward movement of the main cylinder 340.

Further rearward movement of the main cylinder 340 as the movable contact assembly 334 moves toward its open position further increases the pressure of the SF₆ gas in the volume 370. The pressure of the SF₆ gas acts against the second ring member 382 by way of the through holes 390 not covered by the first ring member 380. The spring rate of the springs 389 is selected to be low enough to permit the second ring member 382 to back away from the body 380, i.e., to move toward its rearward position, when the pressure in the volume 370 reaches a predetermined level.

Movement of the second ring member 382 away from the second major surface 380c permits a portion of the SF₆ gas to exit the volume 370 by way of the through holes 390 not covered by the first ring member 381. The escape of the SF₆ gas can prevent the pressure of the SF₆ gas within the volume 370 from increasing substantially above the predetermined level. The valve 302 can thus limit the maximum pressure of the SF₆ gas within the volume 370.

The valve 302 permits the volume 370 to be replenished with the SF₆ gas as the movable contact assembly 334 is subsequently returned to its closed position. In particular, movement of the movable contact assembly 334 from its open to its closed position causes the main cylinder 340 to moved in the forward direction. The forward movement of the main cylinder 340 increases the volume 370, and thereby produces a pressure gradient across the body 380, i.e., the pressure in the volume 370 is lower than the pressure in a volume 372 immediately rearward of the body 380 (the volume 372 is denoted in FIG. 15).

The pressure gradient across the body 380 causes the inlet ring member 381 to move toward its forward position, thereby exposing the through holes 390 previously covered by the inlet ring member 381 (these particular through holes 390, as noted previously, are not covered by the second ring member 382). The pressure gradient across the body 380 causes SF₆ gas present in the volume 372 to flow through the exposed through holes 390 and into the volume 370, thereby replenishing the SF₆ gas within the volume 370.

The use of the springs 389 to bias valve 302 toward its forward position can add to the overall parts count and complexity of the valve 302. Increasing the overall parts count and complexity of the valve 302 can make the valve 302 more costly to produce, can decrease the reliability and the service life of the valve 302, and can necessitate the use of special tooling to assemble the valve 302.

It is believed that the use of multiple springs, such as the springs 389, to bias the second ring member 382 makes it difficult to achieve a substantially uniform bias on the second spring member 382. Moreover, the non-uniformity in the biasing force can increase progressively as the springs 389 age.

Non-uniformity in the biasing force can decrease the potential for the second ring member 382 to adequately seal the through holes 391. Non-uniformities in the biasing force can also increase the potential for the second ring member 391 to skew, wobble, or otherwise become cocked in relation to the body 380 as the second ring member 391 backs away from the body 380, thereby decreasing the reliability of the pressure-limiting function of the valve 302.

### SUMMARY OF THE INVENTION

A preferred embodiment of a valve for a puffer interrupter assembly comprises a body for mounting between a first and a second volume in the puffer interrupter assembly, the body having a plurality of through holes formed therein for permitting a fluid to flow between the first and second volumes.

The valve also comprises a ring member movable between a first position wherein the ring member covers the through holes and thereby substantially prevents the fluid from flowing between the first and the second volumes by way of the through holes, and a second position wherein the first ring member is spaced apart from the through holes and thereby permits the fluid to flow between the first and second volumes by way of the through holes. The valve further comprises a wave spring for biasing the ring member toward the first position.

Another preferred embodiment of a valve for a puffer interrupter assembly comprises a body for mounting between a first and a second volume in the puffer interrupter assembly, the body having a plurality of through holes formed therein for permitting a fluid to flow between the first and second volumes. The valve also comprises a ring member and a wave spring. The wave spring urges the ring member into contact with the body so that the ring member covers the through holes only when a pressure within the first volume is below a predetermined value.

Another preferred embodiment of a valve for a puffer interrupter assembly comprises a body for mounting in the puffer interrupter assembly. The body has a through hole formed therein and extending between a first and a second major surface thereof. The valve also comprises a ring member having a first major surface contacting the second major surface of the body and covering the through hole on a selective basis. The valve also includes a wave spring contacting a second major surface of the ring member.

A preferred embodiment of a puffer interrupter assembly comprises a stationary contact assembly comprising an arcing contact rod fixedly coupled to the stationary contact support, and a contact assembly fixedly coupled to the stationary contact support.

The puffer interrupter assembly also comprises an operating rod movable in an axial direction in relation to the stationary contact assembly, and a movable contact assembly. The movable contact assembly comprises a moving contact cylinder fixedly coupled to the operating rod, an insulating nozzle fixedly coupled to the moving contact cylinder, a piston fixedly coupled to the operating rod for compressing a fluid in a first volume in the puffer interrupter assembly, and arcing contact fingers fixedly coupled to the operating rod.

The movable contact assembly is movable between a first position wherein the moving contact cylinder contacts the contact assembly and the arcing contact fingers contact the arcing contact rod, and a second position wherein the moving contact cylinder is spaced apart from the contact assembly and the arcing contact fingers are spaced apart from the arcing contact rod.

The puffer interrupter assembly also comprises a valve comprising a body for mounting between the first volume and a second volume in the puffer interrupter assembly. The body has a plurality of through holes formed therein for permitting the fluid to flow between the first and second volumes.

The valve also comprises a ring member movable between a first position wherein the ring member covers the through holes and thereby substantially prevents the fluid from flowing between the first and the second volumes by way of the through holes, and a second position wherein the first ring member is spaced apart from the through holes and thereby permits the fluid to flow between the first and second volumes by way of the through holes. The valve further comprises a wave spring for biasing the ring member toward the first position.

### BRIEF DESCRIPTION OF THE DRAWINGS

The foregoing summary, as well as the following detailed description of a preferred method, is better understood when read in conjunction with the appended diagrammatic drawings. For the purpose of illustrating the invention, the drawings show an embodiment that is presently preferred. The invention is not limited, however, to the specific instrumentalities disclosed in the drawings. In the drawings:

FIG. 1 is a cross-sectional side view of a circuit breaker comprising a puffer interrupter assembly having a preferred embodiment of a pressure-limiting valve, with an upper half of the figure depicting a movable contact assembly of the puffer interrupter assembly in its “open” position, and a lower half of the figure depicting the movable contact assembly in its “open” position;

FIG. 2 is a magnified view of the area designated “A” in FIG. 1;

FIG. 3 is a magnified view of the area designated “B” in FIG. 2, depicting an inlet ring and an outlet ring member of the valve shown in FIGS. 1-3 in their respective rearward and forward positions;

FIG. 4A is a magnified view of the area designated “C” in FIG. 3, depicting the inlet ring and an outlet ring member of the valve shown in FIGS. 1-3 in their respective forward positions;

FIG. 4B is a magnified view of the area designated “C” in FIG. 3, depicting the inlet ring and the outlet ring member of the valve shown in FIGS. 1-4A in their respective rearward and forward positions;

FIG. 4C is a magnified view of the area designated “C” in FIG. 3, depicting the inlet ring and an outlet ring member of the valve shown in FIGS. 1-4B in their respective rearward positions;

FIG. 5A is a front view of a body of the valve shown in FIGS. 1-4C;

FIG. 5B is a side view of the body shown in FIG. 5A;

FIG. 6 is a cross-sectional side view of a bushing of the valve shown in FIGS. 1-4C;

FIG. 7A is a front view of an outlet ring member of the valve shown in FIGS. 1-4C;

FIG. 7B is a side view of the outlet ring member shown in FIG. 7A;

FIG. 8A is a front view of an inlet ring member of the valve shown in FIGS. 1-4C;

FIG. 8B is a side view of the inlet ring member shown in FIG. 8A;

FIG. 9A is a perspective view of a wave spring of the valve shown in FIGS. 1-4C;

FIG. 9B is a side view of the wave spring shown in FIG. 9A;

FIG. 10 is a magnified view of the area designated “D” in FIG. 3, depicting a portion of a moving contact support of the puffer interrupter assembly shown in FIGS. 1 and 2;

FIG. 11 is a magnified view of the area designated “E” in FIG. 3, depicting a portion of a support shield of the puffer interrupter assembly shown in FIGS. 1 and 2;

FIG. 12 is a side view of an alternative embodiment of the valve shown in FIGS. 1-4C;

FIG. 13 is a rear perspective view of the alternative embodiment shown in FIG. 12, with a back plate of the valve removed;

FIG. 14 is a cross-sectional side view of a circuit breaker comprising a puffer interrupter assembly having a conventional pressure-limiting valve, depicting a movable contact assembly of the puffer interrupter assembly in its “closed” position;

FIG. 15 is a magnified view of the area designated “F” in FIG. 14; and

FIG. 16 is a cross-sectional side view of a pressure-limiting valve of the puffer interrupter assembly shown in FIGS. 14 and 15.

### DESCRIPTION OF PREFERRED EMBODIMENTS

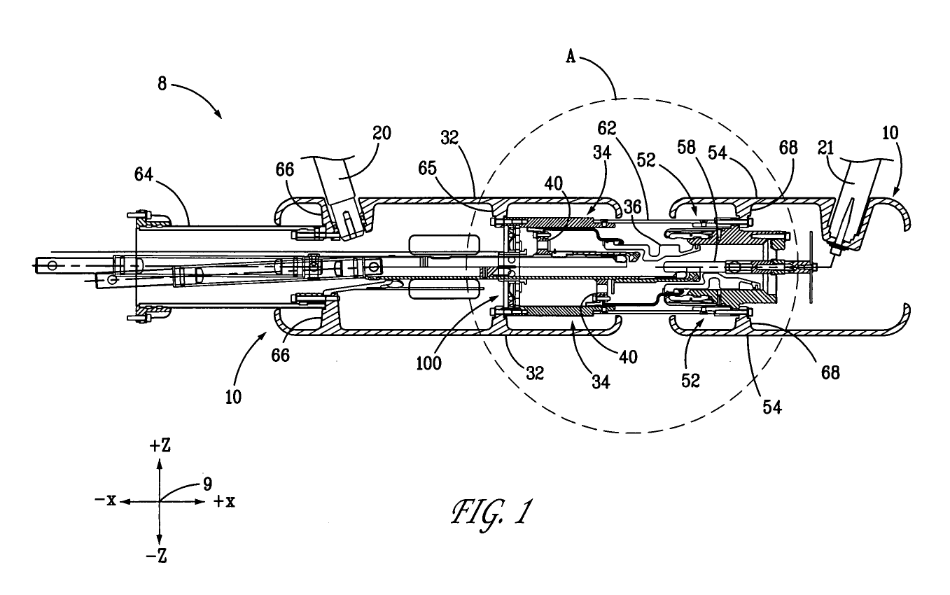

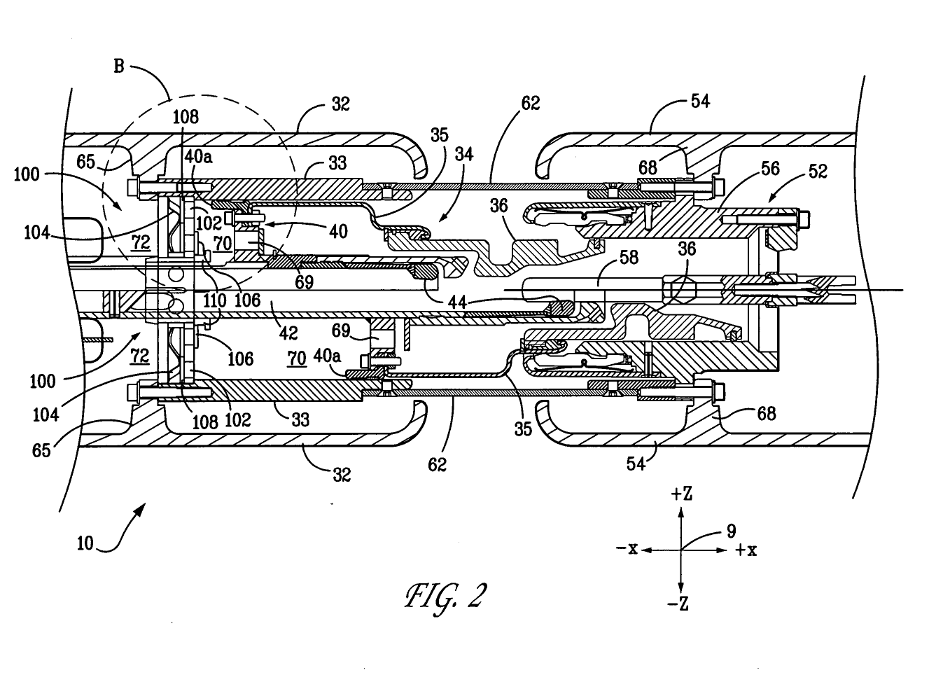

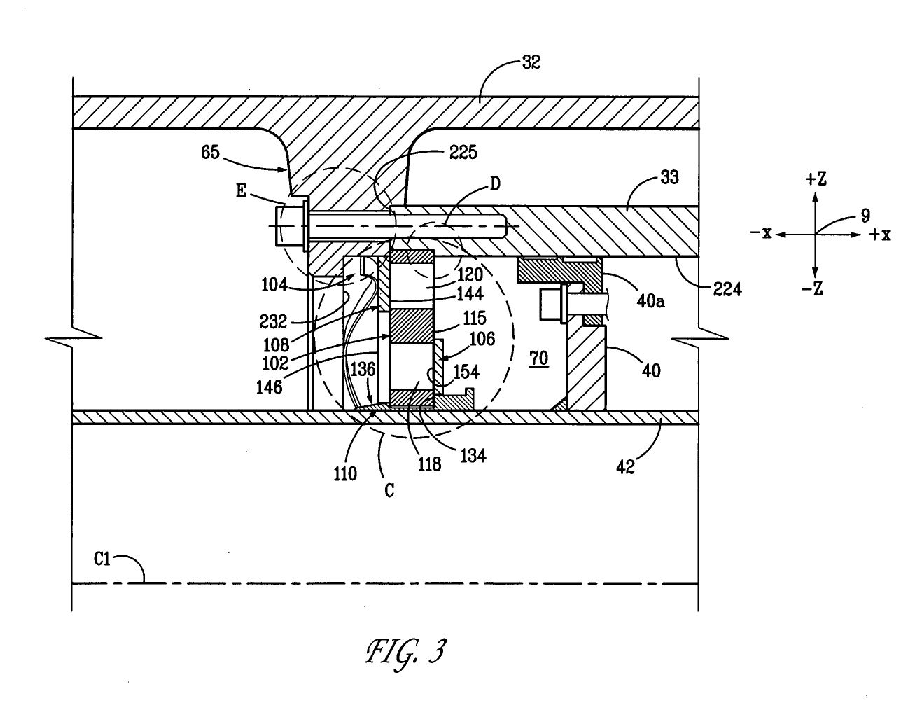

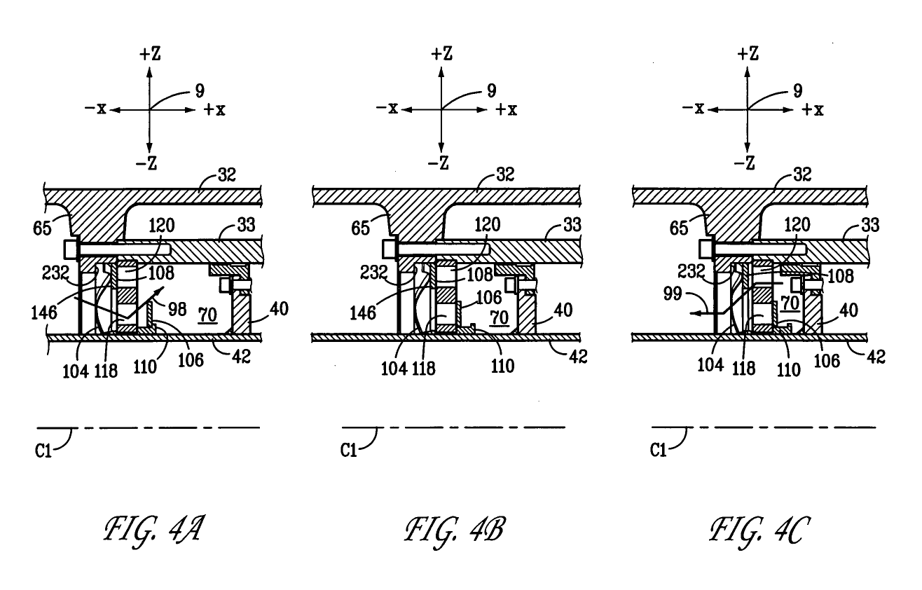

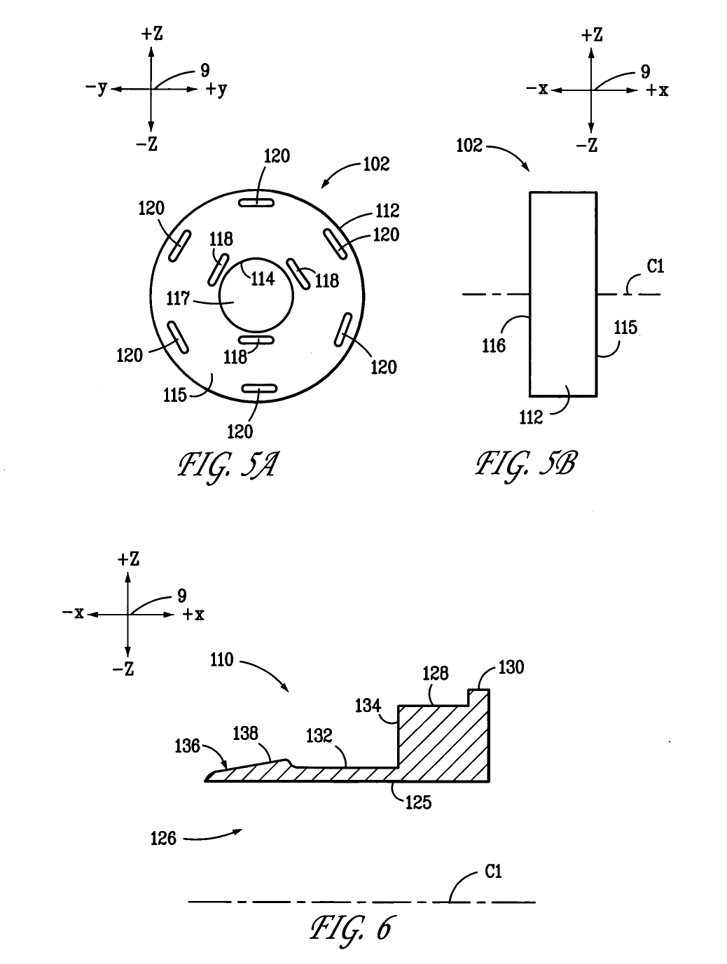

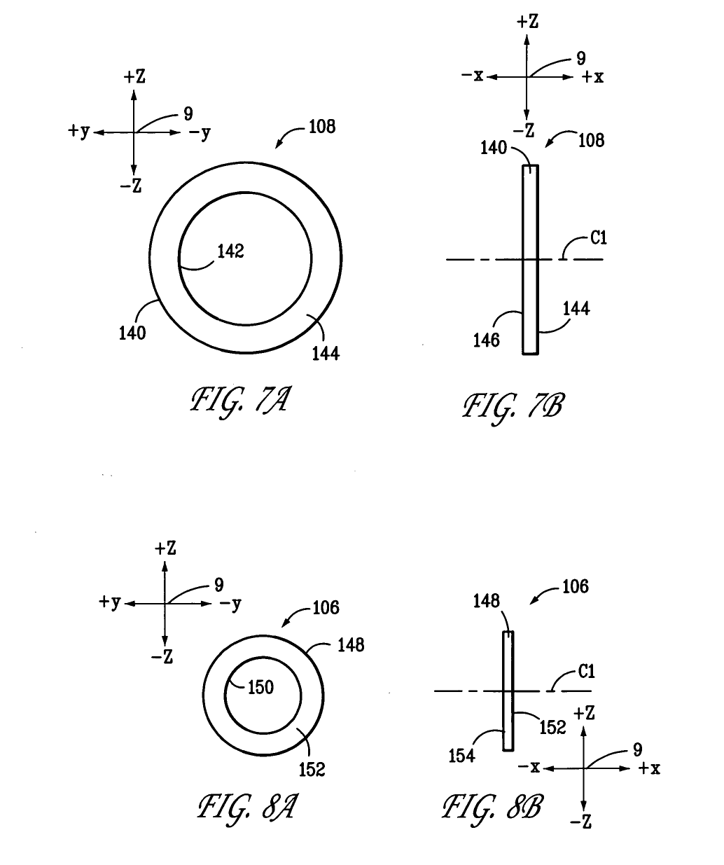

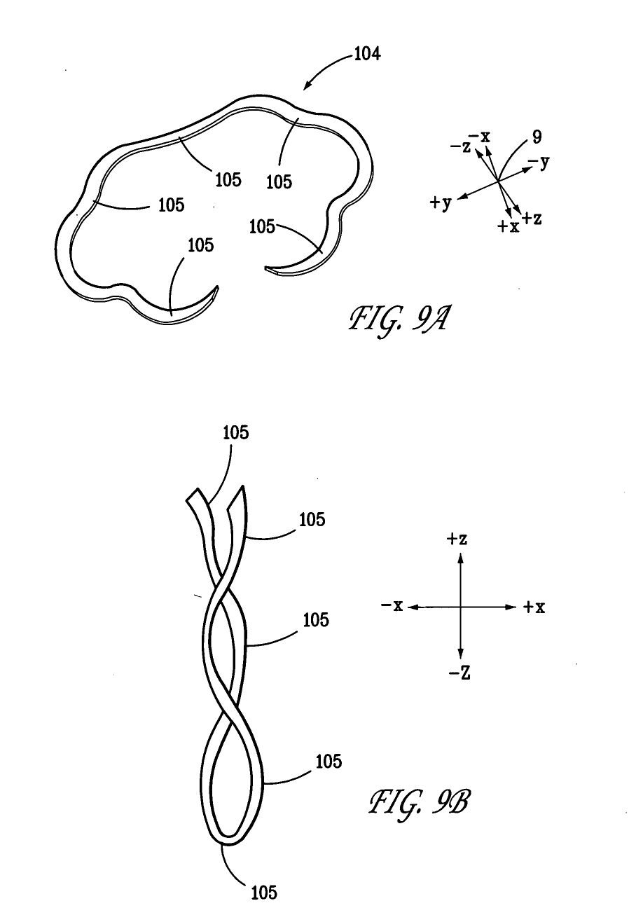

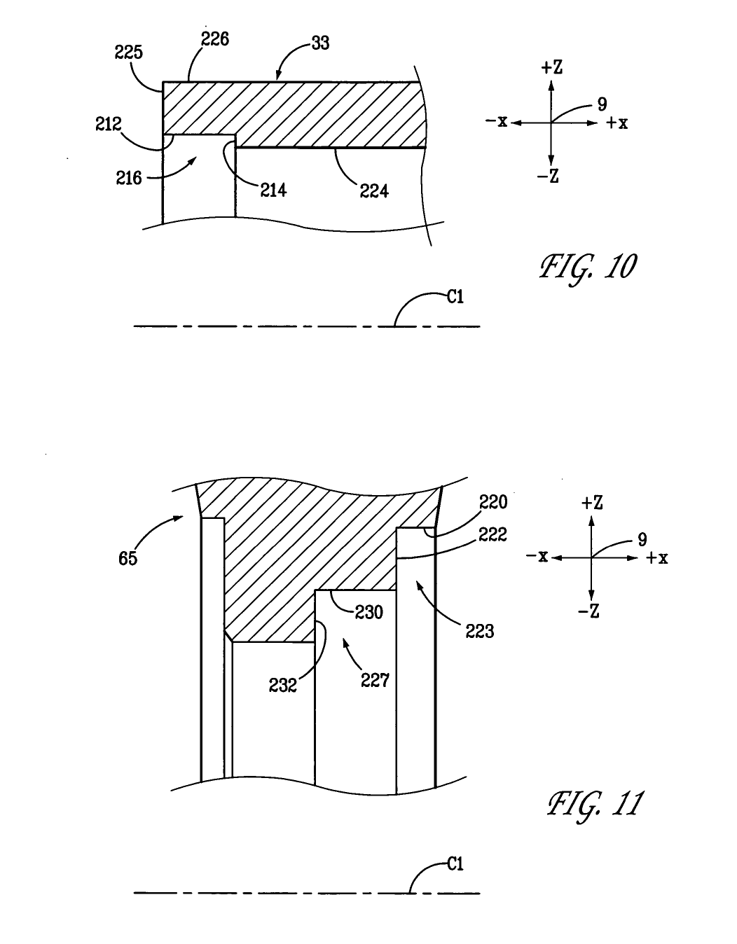

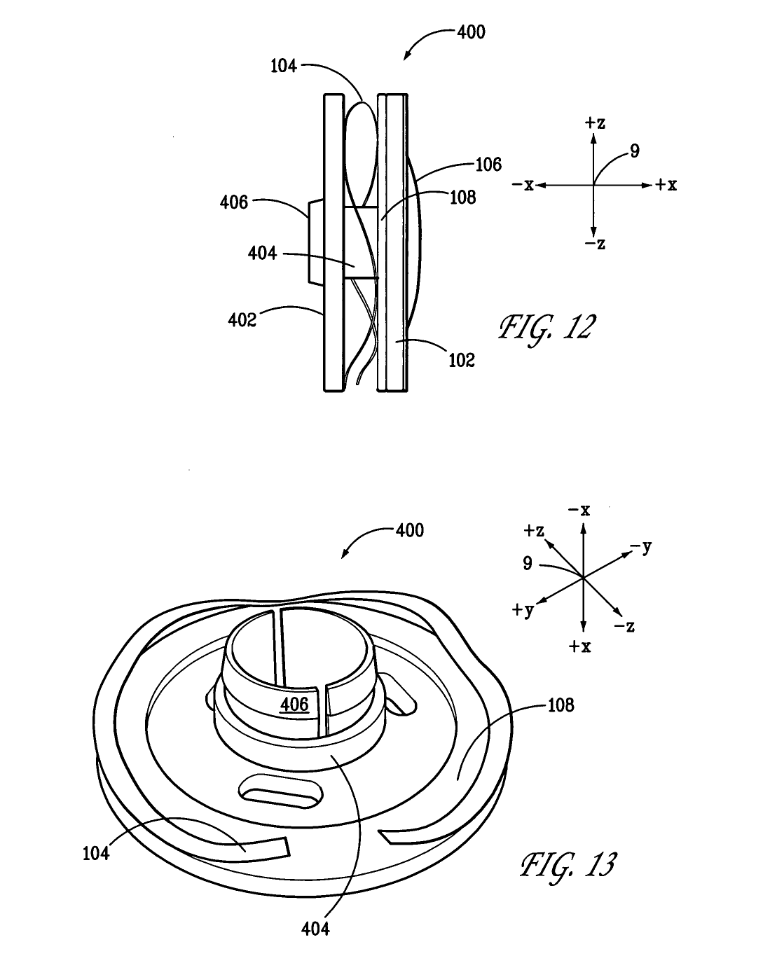

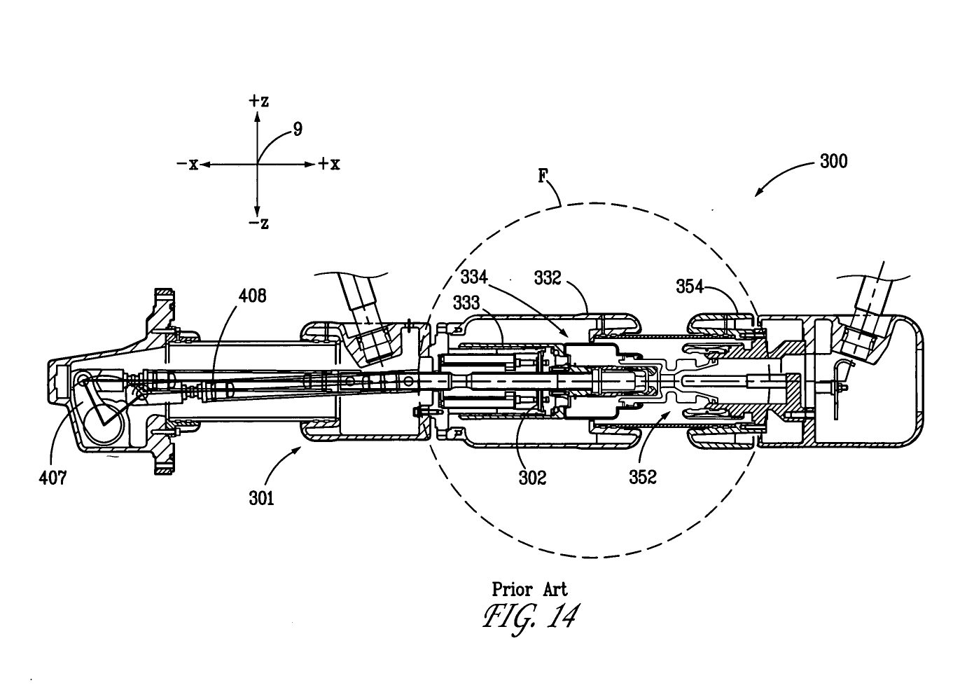

FIGS. 1-14 depict a preferred embodiment of a pressure-limiting valve 100, and various components thereof. The figures are each referenced to the common coordinate system 9 depicted therein.

The valve 100 is described herein connection with a single-phase, dead-tank circuit breaker 8 comprising a puffer interrupter assembly 10 having a movable piston. Details of the circuit breaker 8 and the puffer interrupter assembly 10 are presented for exemplary purposes only, as the valve 100 can be used in conjunction with other types of circuit breakers and other types of puffer interrupter assemblies, including puffer interrupter assemblies having moving cylinders.

The circuit breaker 8 comprises a hermetically-sealed tank (not shown) that houses the puffer interrupter assembly 10. The circuit breaker 8 also comprises an entrance conductor 20 and an exit conductor 21 that extend through the tank, and through a respective entrance bushing insulator and exit bushing insulator (not shown) mounted on the tank (see FIG. 1).

The puffer interrupter assembly 10 comprises a support shield 32, a moving contact support 33, and a movable contact assembly 34. The support shield 32 is electrically and mechanically coupled to the entrance conductor 20. The moving contact support 33 is fixedly coupled to a flange 65 formed along an inner circumference of the support shield 32.

The movable contact assembly 34 comprises a moving contact cylinder 35, and an insulating nozzle 36 fixedly coupled to the moving contact cylinder 35 (see FIG. 2). The movable contact assembly 34 also comprises a piston 40, a blast tube 42, and arcing contact fingers 44.

The piston 40 and the arcing contact fingers 44 are fixedly coupled to the blast tube 42, and the moving contact cylinder 35 is fixedly coupled to the piston 40. The blast tube 42 extends through the support shield 32 and the moving contact support 33. The blast tube 42 can translate axially, i.e., in the “x” direction, in relation to the support shield 32 and the moving contact support 33.

The piston 40 is fixedly coupled to the blast tube 42, and can thus translate axially in relation to the support shield 32 and the moving contact support 33. The piston 40 includes a seal 40a that forms an outer circumference of the piston 40 (see FIG. 3). The seal 40a contacts a major inner surface 224 of the moving contact support 33.

The puffer interrupter assembly 10 also includes an operating lever (not shown), and an operating mechanism (also not shown) that rotates the operating lever on a selective basis. The operating lever is mechanically coupled to an end of the blast tube 42. Rotation of the operating lever causes the blast tube 42 (and the moving contact cylinder 35, insulating nozzle 36, piston 40, and arcing contact fingers 44) to translate in the axial direction.

The puffer interrupter assembly 10 further comprises the valve 100, as noted above. The valve 100, as explained in detail below, is mechanically coupled to the flange 65 of the support shield 32, and to the moving contact support 33. The structure and function of the valve 100 are discussed in detail below.

The puffer interrupter assembly 10 also comprises a stationary contact assembly 52 and a support shield 54 (see FIG. 2). The support shield 54 is electrically and mechanically coupled to the exit conductor 21. The stationary contact assembly 52 a stationary contact support 56. The stationary contact support 56 is positioned within the support shield 54, and is fixedly coupled to a flange 68 formed along an inner circumference of the support shield 54.

The stationary contact assembly 52 also comprises an arcing contact rod 58 and a contact assembly 60. The arcing contact rod 58 is fixedly coupled to, and extends through the stationary contact support 56. The contact assembly 60 is fixedly coupled to an end of the stationary contact support 56, and extends circumferentially around the end of the stationary contact support 56.

A first insulating tube 62 is fixedly coupled to the moving contact support 33, and to the stationary contact support 56. A second insulating tube 64 is fixedly coupled to a flange 66 formed along an inner circumference of the support shield 32.

The free volume within the puffer interrupter assembly 10 and the entrance and exit bushing insulators is filled with a dielectric gas such as sulfur hexafluoride (SF₆). The SF₆ gas can be pressurized to, for example, approximately four to seven atmospheres.

The movable contact assembly 34 is shown in its open position in the upper halves of FIGS. 1 and 2. The movable contact assembly 34 is shown in its closed position in the lower halves of FIGS. 1 and 2. More particularly, the blast tube 42 translates in the axial direction in response to actuation of the operating mechanism, as noted above. Axial movement of the blast tube 42 drives the moving contact cylinder 35 and the arcing contact fingers 44 toward or away from the respective contact assembly 60 and arcing contact rod 58 of the stationary contact assembly 52.

A forward portion of the moving contact cylinder 35 contacts the inner circumference of the contact assembly 60, and the arcing contact fingers 44 contact the arcing contact rod 58 when the movable contact assembly 34 is in its closed position (see FIG. 2). This arrangement establishes electrical contact between the entrance and exit conductors 20, 21, and thereby facilitates the flow of electrical current through the circuit breaker 8. More particularly, the noted arrangement establishes an electrical path comprising the entrance conductor 14, support shield 32, moving contact cylinder 35, arcing contact fingers 44, arcing contact rod 58, contact assembly 60, stationary contact support 56, support shield 54, and exit conductor 21.

Movement of the movable contact assembly 34 to the open position breaks the above-noted contact between the moving contact cylinder 35 and the contact assembly 60, and between the arcing contact fingers 44 and the arcing contact rod 58. Movement of the movable contact assembly 34 to the open position thus interrupts the flow of electrical current between the entrance and exit conductors 20, 21.

The piston 40 is fixedly coupled to the blast tube 42, and therefore translates with the moving contact cylinder 35 and the arcing contact fingers 44. Translation of the piston 40 in the rearward (“−x”) direction, as the movable contact assembly 34 moves from its closed to its open position, compresses the SF₆ gas located within a volume 70 between the valve 100 and the piston 40 (see FIGS. 3-4C).

The valve 100, as explained in detail below, can trap the SF₆ gas within the volume 70, and can thereby cause the SF₆ gas to compress in response to the movement of the piston 40 in the rearward direction. Moreover, the valve 100 can release a portion of the SF₆ gas from the volume 70 when the pressure of the SF₆ gas reaches a predetermined level, and can thereby limit the pressure of the SF₆ gas in the volume 70. Details relating to these features are presented below.

Through holes (not shown) formed in the piston 40 permit the compressed SF₆ gas to flow toward the stationary contact assembly 52 in response to the elevated pressure within the volume 70. The SF₆ gas flows through the nozzle 36 after exiting the through holes in the piston 40 (see FIG. 2). The nozzle 36 directs the SF₆ gas toward the interface between the moving contact cylinder 35 and the contact assembly 60. The nozzle 36 also directs the SF₆ gas toward the interface between the arcing contact fingers 44 and the arcing contact rod 58.

The SF₆ gas can help to cool and quench the arc that forms between the moving contact cylinder 35 and the contact assembly 60 during separation thereof. The SF₆ gas can also help to cool and quench the arc that forms between the arcing contact fingers 44 and the arcing contact rod 58 during separation thereof. (The SF₆ gas can also act as an electrical insulator between the walls of the tank that houses the puffer interrupter assembly 10, and the various components housed within the puffer interrupter assembly 10.)

The valve 100 comprises a body 102, a wave spring 104, an inlet ring member 106, an outlet ring member 108, and a bushing 110 (see FIGS. 3-9B). The body 102 has a substantially circular outer surface 112 (see FIGS. 5A and 5B). The body 102 also includes a substantially circular inner surface 114 that defines a through hole 117 in the body 102. The body 102 further includes a first major surface 115 and a second major surface 116. The first major surface 115 faces the forward (“+x”) direction, and the second major surface 116 faces the rearward (“−x”) direction when the valve 100 is assembled (see FIG. 3).

The body 102 has three inlet holes 118 formed therein (see FIGS. 5A and 5B). The inlet holes 118 are preferably located proximate the inner surface 114, and extend between the first and second major surfaces 115, 116. Each of the inlet holes 118 has an elongated shape as depicted in FIG. 5A. Alternative embodiments of the body 102 can include more or less than three of the inlet holes 118. Moreover, the inlet holes 118 can be formed in shapes different than those shown in FIG. 5A, and can be located in positions on the body 102 other than those depicted in FIG. 5A.

The body 102 has six outlet holes 120 formed therein. The outlet holes 120 are preferably located proximate the outer surface 112, and extend between the first and second major surfaces 115, 116. Each of the outlet holes 120 has an elongated shape as depicted in FIG. 5A. Alternative embodiments of the body 102 can include more or less than six of the outlet holes 120. Moreover, the outlet holes 120 can be formed in shapes different than those shown in FIG. 5A, and can be located in positions on the body 102 other than those depicted in FIG. 5A.

The outlet ring member 108 has a substantially circular outer surface 140, and a substantially circular inner surface 142 (see FIGS. 7A and 7B). The outlet ring member 108 also has a first major surface 144 and a second major surface 146. The first major surface 144 of the outlet ring member 108 faces the second major surface 116 of the body 102 when the valve 100 is assembled (see FIG. 3). The respective diameters of the outer surface 140 and the inner surface 142 are sized so that first major surface 144 covers the outlet holes 120 in the body 102 when the outlet ring member 108 is positioned as depicted in FIG. 3. The significance of this feature is discussed below.

The inlet ring member 106 has a substantially circular outer surface 148, and a substantially circular inner surface 150 (see FIGS. 8A and 8B). The inlet ring member 106 also has a first major surface 152 and a second major surface 154. The second major surface 154 of the inlet ring member 106 faces the first major surface 115 of the body 102 when the valve 100 is assembled (see FIG. 3). The respective diameters of the outer surface 142 and the inner surface 142 are sized so that second major surface 154 covers the inlet holes 118 in the body 102 when the inlet ring member 106 is positioned as depicted in FIG. 3. The significance of this feature is discussed below.

The bushing 110 is preferably formed from a polymeric material such as Teflon. The bushing 110 is positioned over the blast tube 42 of the movable contact assembly 34, as shown in FIGS. 3-4A. In particular, the bushing 110 has a substantially circular inner surface 125 that defines a passage 126 within the bushing 110 (see FIG. 6). The passage 126 receives the blast tube 42 of the moving contact assembly.

The diameter of the inner surface 125 is preferably sized so that the inner surface 125 contacts the blast tube 42. It is believed that the polymeric material from which the bushing 110 is formed permits the outer surface of the blast tube 42 to slide in relation to the inner surface 125 with minimal resistance. The bushing 110 preferably has a plurality of axially-extending slots (not shown) formed therein that facilitate assembly of the bushing 110.

The bushing 110 includes a circumferentially-extending first outer surface portion 128, and a circumferentially-extending first lip 130 that adjoins the first outer surface portion 128 (see FIG. 6). The bushing 110 also includes a circumferentially-extending second outer surface portion 132. The second outer surface portion 132 has a smaller diameter than the first outer surface portion 128. The first and second outer surface portions 128, 132 are oriented substantially parallel to a centerline “C1” of the valve 100.

The bushing 110 also includes a circumferentially-extending third outer surface portion 134 that adjoins each of the first and second outer surface portions 128, 132. The third outer surface portion 134 is substantially perpendicular to each of the first and second outer surface portions 128, 132. The bushing 110 further includes a circumferentially-extending second lip 136 that adjoins the second outer surface portion 132.

The body 102 is positioned around the bushing 110 as shown in FIGS. 3-4C. In particular, the diameter of the inner surface 114 of the body 102 is sized to permit the inner surface 114 to fit over the second outer surface portion 132 of the bushing 110 with minimal clearance. (The second lip 136 has a surface portion 138 that is angled in relation to the centerline C1, as shown in FIG. 6). This feature, it is believed, can make it easier to install the body 102 on the bushing 110 by pushing the body 102 onto the bushing 110 from the rearward (“−x”) direction.)

A radially innermost portion of the body 102 is positioned between the second lip 136 and the third outer surface portion 134 of the bushing 110 when the valve 100 is assembled, as shown in FIG. 3. This arrangement can prevent substantial relative movement in the axial direction between the body 102 and the bushing 110.

The body 102 is restrained by the support shield 32 and the moving contact support 33. In particular, the moving contact support 33 has a circumferentially-extending first inner surface 212 and an adjoining, circumferentially-extending second inner surface 214 (see FIG. 10). The first inner surface 212 is oriented substantially parallel to the centerline C1, and the second inner surface 214 is oriented substantially perpendicular to the centerline C1. The first and second inner surfaces 212, 214 define a notch 216.

The notch 216 receives a radially-outermost portion of the body 102, as shown in FIGS. 3-4C. The diameter of the outer surface 112 of the body 102 is preferably sized so that minimal clearance exists between the outer surface 112 and the first inner surface 212 of the moving contact support 33. Preferably, the length (x-axis dimension) of the outer surface 112 of the body 102 is approximately equal to the length of the first inner surface 212.

The flange 65 of the support shield 32 has a circumferentially-extending first surface portion 220, and a circumferentially-extending second surface portion 222 (see FIG. 12). The first surface portion 220 is oriented substantially parallel to the centerline C1. The second surface portion 222 adjoins the first surface portion 220, and is oriented substantially perpendicular to the centerline C1. The first and second surface portions 220, 222 define a notch 223.

The notch 223 receives a portion of the moving contact support 33, as shown in FIGS. 3-4C. In particular, an end surface 225 of the moving contact support 33 abuts the second surface portion 222 of the flange 65. The diameter of the first surface portion 220 is preferably sized so that a portion of an outer surface 226 of the moving contact support 33 fits within the first surface portion 220 with minimal clearance. The moving contact support 33 can be secured to the flange 65 using conventional fasteners, as shown in FIGS. 3-4C.

The flange 65 and the moving contact support 33 restrain the body 102 in the axial direction. In particular, the notch 216 receives a radially-outermost portion of the body 102, as noted above. The respective inner diameters of the second surface portion 222 of the flange 65 and the second inner surface 214 of the moving contact support 33 are less than the diameter of the outer surface 112 of the body 102, as shown in FIG. 3. Moreover, the length of the outer surface 112 is approximately equal to the length of the first inner surface 212 of the moving contact support 33. The body 102 is thus restrained from substantial axial movement by contact with the second inner surface 214 of the moving contact support 33 and the second surface portion 222 of the flange 65.

Contact between the first inner surface 212 of the moving contact support 33 and the outer surface 112 of the body 102 restrains the body 102 from substantial lateral (“y” and “z”-direction) movement.

The flange 65 includes a circumferentially-extending third surface portion 230 that adjoins the second surface portion 222, and a circumferentially-extending fourth surface portion 232 that adjoins the third surface portion 230 (see FIG. 11). The third surface portion 230 is oriented substantially parallel to the centerline C1. The fourth surface portion 232 is oriented substantially perpendicular to the centerline C1. The third and fourth surface portions 230, 232 define a notch 227 in the flange 65.

The notch 227 receives a radially-outermost portion of the outlet ring member 108, and a radially-outermost portion of the wave spring 104. In particular, the outlet ring member 108 is located rearward of the body 102 so that the first major surface 144 of the outlet ring member 108 faces the second major surface of the body 102, as noted previously. The diameter of the outer surface 140 of the outlet ring member 108 is sized so that minimal clearance exists between the outer surface 140 of the outlet ring member 108 and the third surface portion 230 of the flange 65 (see FIG. 3). The outlet ring member 108 is thus restrained from substantial lateral movement by the third surface portion 230 of the flange 65. The outlet ring member 108 can translate axially in relation to the flange 65 and the body 102, between a forward position (FIGS. 3-4B) and a rearward position (FIG. 4C).

The wave spring 104 is positioned substantially between the fourth surface portion 232 of the flange 65 and the second major surface 146 of the outlet ring member 108 (see FIGS. 3-4C). The wave spring 104 can be of conventional design, i.e., the wave spring 104 can be a one-turn edge-wound spring washer formed from flat spring wire (see FIGS. 9A and 9B). The wave spring 104 preferably has five crests 105 formed therein. Preferably, the crests 105 are circumferentially spaced by substantially equal intervals.

The wave spring 104 is compressed by the fourth surface portion 232 of the flange 65 and the second major surface 146 of the outlet ring member 108, thereby causing the wave spring 104 to bias the outlet ring member 108 toward its forward position (see FIGS. 3-4C). More particularly, the wave spring 104 urges the first major surface 144 of the outlet ring member 108 against the second major surface 116 of the body 102 when the pressure in the volume 70 is below a predetermined level.

The inlet ring member 106 is positioned over the first outer surface portion 128 of the bushing 110 so that the second major surface 154 of the inlet ring member 106 faces the first major surface 115 of the body 102 (see FIGS. 3-4C). The diameter of the inner surface 142 of the inlet ring member 106 is sized so that the inlet ring member 106 fits over the first outer surface portion 128 with minimal clearance. The inlet ring member 106 is thus restrained from substantial lateral movement by the first outer surface portion 128. The inlet ring member 106 can translate axially in relation to the bushing 110 and the body 102, between a forward position (FIG. 4A) a rearward position (FIGS. 3, 4B, 4C).

The free volume within the puffer interrupter assembly 10 (including the volume 70) is filled with SF₆ gas, as discussed above. The valve 100 can limit the pressure of the SF₆ gas within the volume 70 as the movable contact assembly 34 moves from its closed position to its open position. The valve 100 can also permit SF₆ gas to be drawn into the volume 70 when the movable contact assembly 34 moves from its open position to its closed position. Details relating to these features are as follows.

The piston 40 moves in the rearward (“−x”) direction when the movable contact assembly 34 moves from its closed to its open position, as discussed above. The valve 100 initially traps the SF₆ gas in the volume 70. The initial movement of the piston 40 thus compresses the SF₆ gas within the volume 70. The resulting increase in pressure of the SF₆ gas can be substantial when a relatively high current is flowing through the circuit breaker 8, due to the heating (and the corresponding expansion) of the SF₆ gas caused by the arc that forms between the moving contact cylinder 35 and the contact assembly 60, and between the contact fingers 44 and the arcing contact rod 58.

The inlet ring member 106 is urged into its rearward position by the increased pressure within the volume 70 caused by the rearward movement of the piston 40 (see FIG. 4B). The inlet ring member 106 covers the inlet holes 118 in the body 102 when the inlet ring member 106 is in its rearward position. The inlet ring member 106 thus seals the inlet holes 118 and prevents substantial amounts of SF₆ gas from flowing out of the volume 70 by way of the inlet holes 118 as the movable contact assembly 34 initially moves toward its open position.

The outlet ring member 108 seals the outlet holes 120 in the body 102 when the pressure of the SF₆ gas within the volume 70 is below a predetermined value. In particular, the wave spring 104 biases the outlet ring member 108 toward its closed position, and the outlet ring member 108 covers the outlet holes 120 when the outlet ring member 108 is in its closed position (see FIG. 4B).

The spring rate (spring constant) and preload of the wave spring 104 are selected so as to be high enough to cause the wave spring 104 to exert a force sufficient to hold the outlet ring member 108 in its closed position, against the second major surface 116 of the body 102, as the moving contact assembly 34 initially moves toward its open position (under both high and low-current conditions). (The spring load is thus application dependent and a particular value is not specified herein.) The outlet ring member 108 thus seals the outlet holes 120 during the initial period of movement of the movable contact assembly 34.

Movement of the movable contact assembly 34 from its closed to its open position causes the piston 40 to move rearward, as discussed previously. The sealing of the inlet and outlet holes 118, 120 by the respective inlet and outlet rings 106, 108 causes the pressure of the SF₆ gas within the volume 70 to increase in response to the initial rearward movement of the piston 40.

Further rearward movement of the piston 40 as the movable contact assembly 34 moves toward its open position further increases the pressure of the SF₆ gas in the volume 70. The pressure of the SF₆ gas acts against the outlet ring member 108 by way of the outlet holes 120 in the body 102. The spring rate of the wave spring 104 is selected to be low enough to permit the outlet ring member 108 to back away from the body 102, i.e., to move toward its rearward position, when the pressure in the volume 70 reaches a predetermined level (see FIG. 4C). In other words, the pressure of the SF₆ gas within the volume 70 eventually reaches a level where the SF₆ gas exerts a force on the outlet ring member 108 that is sufficient to overcome the forward bias of the wave spring 104 and move the outlet ring member 108 rearward, away from the second major surface 116 of the body 102.

Movement of the outlet ring member 108 away from the second major surface 116 permits a portion of the SF₆ gas to exit the volume 70 by way of the outlet holes 120. The path of the SF₆ gas flowing through the outlet holes 120 in this manner is represented by the arrow 99 in FIG. 4C. The escape of the SF₆ gas can prevent the pressure of the SF₆ gas within the volume 70 from increasing substantially above the predetermined level. The valve 100 can thus limit the maximum pressure of the SF₆ gas within the volume 70.

Limiting the maximum pressure of the SF₆ in the volume 70 gas can lower the potential for stalling or excessive damping of the piston 40 as the movable contact assembly 34 moves to its open position. Stalling or excessive damping, as discussed above, can prevent the moving contact cylinder 35 and the contact fingers 44 from separating from the respective contact assembly 60 and arcing contact rod 58 at a proper rate, and can thereby lead to excessive arcing therebetween. Limiting the maximum pressure of the SF₆ gas can also lower the potential for the SF₆ gas to enter the arc region at an excessive velocity or flow. Excessive velocity or flow of the SF₆ gas can adversely affect the cooling and quenching of the arc.

The outlet ring member 108 returns to its forward position in response to the bias of the wave spring 104 when the pressure of the SF₆ gas within the volume 70 decreases below the predetermined level. Thus, the outlet ring member 108 is automatically restored to its forward position when pressure-limiting function of the valve 100 is no longer required, e.g., when the movable contact assembly 34 has completed its movement to the open position.

The valve 100 permits the volume 70 to be replenished with the SF₆ gas as the movable contact assembly 34 is subsequently returned to its closed position. In particular, movement of the movable contact assembly 34 from its open to its closed position causes the piston 40 to moved in the forward direction. The forward movement of the piston 40 increases the volume 70, and thereby produces a pressure gradient across the body 102, i.e., the pressure in the volume 70 is lower than the pressure in a volume 72 within the support shield 32 immediately rearward of the body 102 (the volume 72 is denoted in FIG. 2).

The pressure gradient across the body 102 causes the inlet ring member 106 to move toward its forward position, thereby exposing the inlet holes 118 in the body 102 (see FIG. 4A). The pressure gradient across the body 102 causes SF₆ gas present in the volume 72 to flow through the inlet holes 118 and into the volume 70, thereby replenishing the SF₆ gas within the volume 70. The path of the SF₆ gas flowing through the inlet holes 118 in this manner is represented by the arrow 98 in FIG. 4A.

The valve 100 can thus perform the above-descried pressure-limiting function, and can thereafter be reconfigured to permit replenishment of the SF₆ gas on an automatic basis, i.e., with no intervention on the part of the operator of the circuit breaker 8.

The valve 100 can perform the above-noted functions using a relatively low number of parts, arranged in a relatively simple kinematic relationship in comparison to conventional pressure-limiting valves such as the valve 302. The relatively low overall parts count and the relative simplicity of the valve 100, its is believed, can potentially make the valve 100 less costly to produce, more reliable, and longer lasting than a conventional valve of comparable capabilities. Moreover, it is believed that the valve 100 can be assembled without the use of special tooling.

The outlet ring member 108 can translate between its forward and rearward positions in a substantially uniform manner. In particular, the outlet ring member 108 is biased by a single component, i.e., the wave spring 104. It is believed that this arrangement produces a substantially uniform biasing force on the outlet ring member 108 initially, and throughout the service life of the valve 100.

The substantially uniform biasing force on the outlet ring member 108 can increase the potential for the outlet ring member 108 to adequately seal each of the outlet holes 120. The substantially uniform biasing force can also lower the potential for the outlet ring member 108 to skew, wobble, or otherwise become cocked in relation to the body 202 as the outlet ring member 108 backs away from the body 202. The substantially uniform biasing force can thus increase the reliability of the pressure-limiting function of the valve 100. Conventional valves such as the valve 302, as discussed above, usually include multiple springs to bias the valve in a closed position. Substantial uniformity in the biasing force exerted by multiple springs is believed to be relatively difficult to achieve, particularly throughout the service life of the conventional valve.

It is to be understood that even though numerous characteristics and advantages of the present invention have been set forth in the foregoing description, together with details of the structure and function of the invention, the disclosure is illustrative only, and changes may be made in detail, especially in matters of shape, size, and arrangement of the parts, within the principles of the invention.

For example, more than one of the wave springs 104 can be used in alternative embodiments of the valve 100. The multiple wave springs 104 can be arranged in a nested or a crest-to-crest relationship. Also, the use of the inlet ring member 106 and the inlet holes 118 can be eliminated in alternative embodiments. An inlet ring member similar to the first ring member 381 of the conventional valve 302, and the outlet holes 120 out can be used in its place.

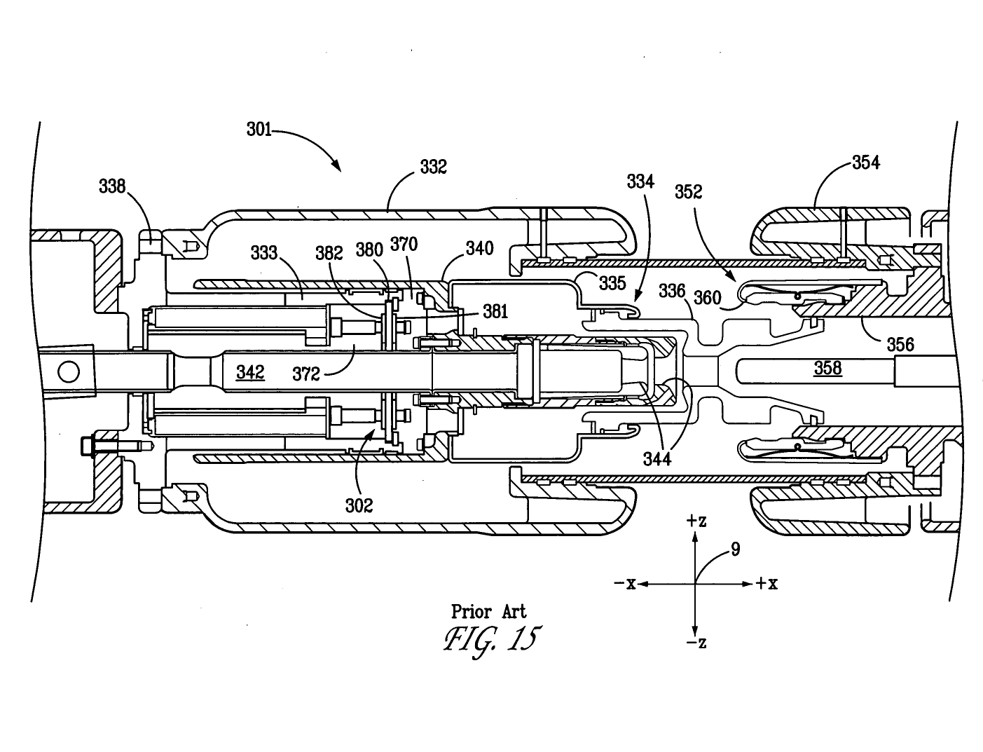

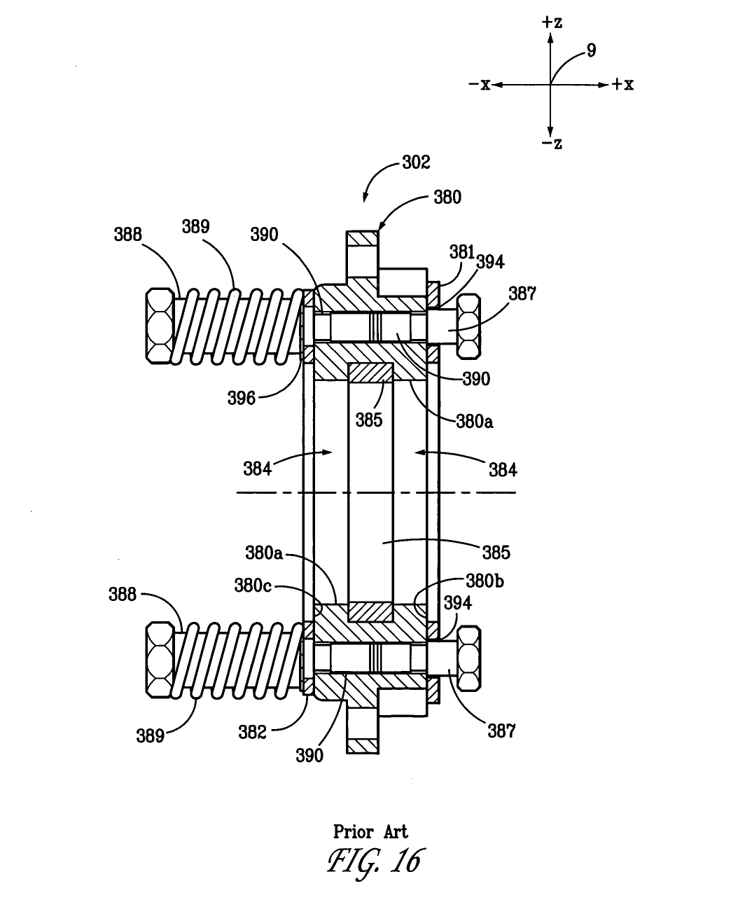

FIGS. 12 and 13 depict an alternative embodiment of the valve 100. In particular, FIGS. 12 and 13 depict a valve 400 that can be installed in a puffer interrupter assembly such as the puffer interrupter assembly 9. The valve 400 can be installed without a need to specially configure the flange 66 or the moving contact support 33 to accommodate the valve.

The valve 400 includes a back plate 402, a spacer 404, and a bushing 406. The valve 400 is otherwise substantially identical to the valve 100, and common reference numerals are used in the figures to depict common components of the valves 100, 400.

The back plate 402 is positioned rearward of the body 202, and over a portion of the bushing 406. (The bushing 406 is elongated in comparison to the bushing 110, to accommodate the back plate 402. The bushing 406 is otherwise substantially identical to the bushing 110.)

The spacer 404 is positioned between the body 102 and the back plate 402 to maintain a predetermined spacing therebetween. The back plate 402 has an outer circumferential surface 405. The back plate 402 can be secured within a component of a puffer interrupter assembly, such as a moving contact support, by an interference fit between the outer circumferential surface 405, and an inner surface of the moving contact support. The body 102 can be likewise be secured within the moving contact support by an interference fit between the outer circumferential surface 112 thereof and the inner surface of the moving contact support.

The wave spring 104 is positioned between the back plate 402 and the outlet ring member 108. The wave spring 104 reacts against the back plate 402, and thereby biases the outlet ring member 108 in the forward direction, toward the second major surface 116 of the body 102. The valve 400 otherwise functions in a manner substantially identical to the valve 100.

### Parts List

Circuit breaker 8
Puffer interrupter assembly 10
Entrance conductor 20
Exit conductor 21
Support shield 32
Moving contact support 33
Movable contact assembly 34
Moving contact cylinder 35 (of movable contact assembly 34)
Insulating nozzle 36
Piston 40
Seal 40a (of piston 40)
Blast tube 42
Arcing contact fingers 44
Stationary contact assembly 52
Support shield 54 (of stationary contact assembly 52)
Stationary contact support 56
Arcing contact rod 58
Contact assembly 60
First insulating tube 62
Second insulating tube 64
Flange 65 (of support shield 33)
Flange 66
Flange 68 (of support shield 54)
Volume 70 (between piston 40 and valve 100)
Volume 72 (immediately rearward of valve 100)
Valve 100
Body 102
Wave spring 104
Crests 105 (of wave spring 104)
Inlet ring member 106
Outlet ring member 108
Bushing 110
Outer surface 112 (of body 102)
Inner surface 114 (of body 102)
First major surface 115
Second major surface 116
Through hole 117 (in body 102)
Inlet holes 118
Outlet holes 120
Inner surface 125 (of bushing 110)
Passage 126 (in bushing 110)
First outer surface portion 128 (of bushing 110)
First lip 130
Second outer surface portion 132
Third outer surface portion 134
Second lip 136
Surface portion 138 (of second lip 136)
Outer surface 140 (of outlet ring member 108)
Inner surface 142
First major surface 144
Second major surface 146
Outer surface 148 (of inlet ring member 106)
Inner surface 150
First major surface 152
Second major surface 154
First inner surface 212 (of moving contact support 33)
Second inner surface 214
Notch 216 (in moving contact support 33)
First surface portion 220 (of flange 218)
Second surface portion 222
Notch 223 (in flange 65)
Major inner surface 224 (of moving contact support 33)
End surface 225
Outer surface 226
Notch 227 (in flange 65)
Third surface portion 230 (of flange 65)
Fourth surface portion 232
Circuit breaker interrupter 300
Puffer interrupter assembly 301
Valve 302
Support shield 332
Moving contact support 333
Movable contact assembly 334
Moving contact cylinder 335
Insulating nozzle 336
Main cylinder 340
Blast tube 342
Arcing contact fingers 444
Stationary contact assembly 352
Support shield 354 (of stationary contact assembly 352)
Stationary contact support 356
Arcing contact rod 358
Contact assembly 360
Contact support 333
Connecting plate 338
Valve 302
Volume 370 (between main cylinder 340 and valve 302)
Volume 372 (immediately rearward of valve 302)
Body 380 (of valve 302)
Inner circumferential surface 380a (of body 380)
First major surface 380b
Second major surface 380c
First ring member 381
Second ring member 382
Bushing 385
Posts 387
Posts 388
Through holes 390 (in body 380)
Through holes 394 (in first ring member 381)
Valve 400
Back plate 402 (of valve 400)
Spacer 404
Outer circumferential surface (of back plate 402)
Bushing 406
Operating lever 407
Insulated operating rod 408

1. A valve for a puffer interrupter assembly, comprising:
a body for mounting between a first and a second volume in the puffer interrupter assembly, the body having a plurality of through holes formed therein for permitting a fluid to flow between the first and second volumes;
a ring member movable between a first position wherein the ring member covers the through holes and thereby substantially prevents the fluid from flowing between the first and the second volumes by way of the through holes, and a second position wherein the first ring member is spaced apart from the through holes and thereby permits the fluid to flow between the first and second volumes by way of the through holes; and
a wave spring for biasing the ring member toward the first position.

2. The puffer interrupter assembly of claim 1, wherein the wave spring biases the ring member toward the first position so that the ring member is in the first position only when a pressure of the fluid in the first volume is less than a predetermined amount.

3. The puffer interrupter assembly of claim 1, wherein the body has a second plurality of holes formed therein, and the puffer interrupter assembly further comprises a second ring member, the second ring member being movable between a first position wherein the second ring member covers the second plurality of through holes and thereby substantially prevents the fluid from passing between the first and second volumes by way of the second plurality of through holes, and a second position wherein the second ring member is spaced apart from the second plurality of through holes and thereby permits the fluid to pass between the first and second volumes by way of the second plurality of through holes.

4. The puffer interrupter assembly of claim 3, wherein the second ring member is urged toward the first position of the second ring member in response to a pressure of the fluid in the first volume.

5. The puffer interrupter assembly of claim 1, wherein the wave spring holds the first ring member in the first position when the pressure in the first volume is below a predetermined value, and the wave spring permits the first ring member to move to the second position in response to the pressure in the first volume when the pressure in the first volume is approximately equal to at least the predetermined pressure.

6. The valve of claim 3, further comprising a bushing for slidably coupling the body to a blast tube of the puffer interrupter assembly.

7. The puffer interrupter assembly of claim 6, wherein the bushing has a circumferentially-extending surface, and the second ring member is positioned around the circumferentially-extending surface.

8. The puffer interrupter assembly of claim 7, wherein the second ring member is positioned around the circumferentially-extending surface so that the second ring member slides between the first and second position of the second ring member on the circumferentially-extending surface.

9. The puffer interrupter assembly of claim 1, wherein the wave spring for biasing the first ring member toward the first position comprises not more than one wave spring.

10. The puffer interrupter assembly of claim 3, wherein the plurality of holes are located proximate an outer circumference of the body and the second plurality of holes are located proximate an inner circumference of the body.

11. The valve of claim 1, wherein the wave spring can be positioned between the ring member and a surface of a support shield of the puffer interrupter assembly.

12. The valve of claim 1, further comprising a back plate, wherein the wave spring can be positioned between the first ring member and the back plate.

13. The puffer interrupter assembly of claim 3, wherein the second ring member can move from its first to its second position when a pressure of the fluid in the first volume is less than a pressure of the fluid in the second volume.

14. The puffer interrupter assembly of claim 6, wherein the body is substantially restrained in a axial direction by a lip and a circumferentially-extending surface of the bushing.

15. The puffer interrupter assembly of claim 1, wherein the body can be substantially restrained by a moving contact support and a support shield of the puffer interrupter assembly.

16. The puffer interrupter assembly of claim 15, wherein an outer circumferential portion of the body can be positioned in a notch formed in the moving contact support, and in a notch formed in a flange of the support shield.

17. The valve of claim 11, wherein at least a portion of the wave spring can be positioned in a notch formed in a flange of the support shield.

18. The valve of claim 11, the wave spring can react against a circumferentially-extending surface of the support shield.

19. The puffer interrupter assembly of claim 3, wherein the ring member contacts a first major surface of the body when the ring member is in its first position, and the second ring member contacts a second major surface of the body when the second ring member is in its first position.

20. A valve for a puffer interrupter assembly, comprising:
a body for mounting between a first and a second volume in the puffer interrupter assembly, the body having a plurality of through holes formed therein for permitting a fluid to flow between the first and second volumes;
a ring member; and
a wave spring, wherein the wave spring urges the ring member into contact with the body so that the ring member covers the through holes only when a pressure within the first volume is below a predetermined value.

21. The puffer interrupter assembly of claim 20, wherein the body has a second plurality of holes formed therein, and the puffer interrupter assembly further comprises a second ring member, the second ring member being movable between a first position wherein the second ring member contacts the body so that the second ring member covers the second plurality of through holes and thereby substantially prevents the fluid from passing between the first and second volumes by way of the second plurality of through holes, and a second position wherein the second ring member is spaced apart from the body and thereby permits the fluid to pass between the first and second volumes by way of the second plurality of through holes.

22. The puffer interrupter assembly of claim 21, wherein the second ring member is urged toward the first position of the second ring member in response to a pressure of the fluid in the first volume.

23. The puffer interrupter assembly of claim 20, wherein the wave spring permits the first ring member to back away from the body when pressure in the first volume approximately than the predetermined pressure.

24. The valve of claim 20, further comprising a bushing for slidably coupling the body to a blast tube of the puffer interrupter assembly.

25. The valve of claim 20, wherein the wave spring can be positioned between the ring member and a surface of a support shield of the puffer interrupter assembly.

26. The valve of claim 20, further comprising a back plate, wherein the wave spring can be positioned between the first ring member and the back plate.

27. The puffer interrupter assembly of claim 21, wherein the second ring member can move from its first to its second position when a pressure of the fluid in the first volume is less than a pressure of the fluid in the second volume.

28. The puffer interrupter assembly of claim 24, wherein the body is substantially restrained in a axial direction by a lip and a circumferentially-extending surface of the bushing.

29. The puffer interrupter assembly of claim 20, wherein the body can be substantially restrained by a moving contact support and a support shield of the puffer interrupter assembly.

30. The valve of claim 29, wherein at least a portion of the wave spring can be positioned in a notch formed in a flange of the support shield.

31. The valve of claim 29, the wave spring can react against a circumferentially-extending surface of the support shield.

32. A valve for a puffer interrupter assembly, comprising:
a body for mounting in the puffer interrupter assembly, the body having a through hole formed therein and extending between a first and a second major surface thereof;
a ring member having a first major surface contacting the second major surface of the body and covering the through hole on a selective basis; and
a wave spring contacting a second major surface of the ring member.

33. A puffer interrupter assembly, comprising:
a stationary contact assembly comprising an arcing contact rod fixedly coupled to the stationary contact support, and a contact assembly fixedly coupled to the stationary contact support;
a blast tube movable in an axial direction in relation to the stationary contact assembly;
a movable contact assembly comprising a moving contact cylinder fixedly coupled to the blast tube, an insulating nozzle fixedly coupled to the moving contact cylinder, a piston fixedly coupled to the blast tube for compressing a fluid in a first volume in the puffer interrupter assembly, and arcing contact fingers fixedly coupled to the blast tube, the movable contact assembly being movable between a first position wherein the moving contact cylinder contacts the contact assembly and the arcing contact fingers contact the arcing contact rod, and a second position wherein the moving contact cylinder is spaced apart from the contact assembly and the arcing contact fingers are spaced apart from the arcing contact rod; and
a valve comprising a body for mounting between the first volume and a second volume in the puffer interrupter assembly, the body having a plurality of through holes formed therein for permitting the fluid to flow between the first and second volumes, a ring member movable between a first position wherein the ring member covers the through holes and thereby substantially prevents the fluid from flowing between the first and the second volumes by way of the through holes, and a second position wherein the first ring member is spaced apart from the through holes and thereby permits the fluid to flow between the first and second volumes by way of the through holes, and a wave spring for biasing the ring member toward the first position.

34. The puffer interrupter assembly of claim 33, further comprising a support shield and a moving contact support fixedly coupled to the support shield, wherein the wave spring is positioned between the ring member and a surface of the support shield.

35. The puffer interrupter assembly of claim 34, wherein the body is substantially restrained by the moving contact support and the support shield.

36. The puffer interrupter assembly of claim 35, wherein an outer circumferential portion of the body is positioned in a notch formed in the moving contact support, and in a notch formed in a flange of the support shield.

37. The valve of claim 34, wherein the wave spring reacts against a circumferentially-extending surface of the support shield.
